(19) United States
(12) Patent Application Publication
(10) Pub. No.: US 2015/0349677 A1
(43) Pub. Date: Dec. 3, 2015

(54) DC BRUSHLESS MOTOR CONTROL SYSTEM APPLICABLE FOR AC POWER

(71) Applicant: DYNA RECHI CO., LTD, Pingtung County (TW)

(72) Inventors: Meng- Huan Li, Pingtung County (TW); Hang-Sheng Chen, Pingtung County (TW)

(73) Assignee: DYNA RECHI CO., LTD, Pingtung County (TW)

(21) Appl. No.: 14/294,380

(22) Filed: Jun. 3, 2014

(51) Int. Cl. H02P 6/00; F24F 11/00

(52) U.S. Cl. CPC H02P 6/002; F24F 11/001; F24F 11/006; F24F 11/0076; F24F 2011/0047; F24F 2011/0061

(57) ABSTRACT

A control system electrically coupled between a main control module and a DC brushless motor includes a switching power conversion circuit, a voltage conversion circuit, a central processing circuit, a motor driving circuit and a switching circuit. The switching power conversion circuit is connected to the air-conditioning main control module for receiving an AC power, and rectifying, bucking and filtering the AC power to form and supply a stable DC power for the operation of the DC brushless motor, so that a conventional air-conditioning system converts AC signals into DC signal to control and drive DC brushless motor, so as to achieve the power saving effect without the need of changing the existing pipeline wiring and control interface.

### FIELD OF THE INVENTION

The present invention relates to a control system, and more particularly to the control system that converts an input Alternate Current (AC) signal into a Direct Current (DC) signal to control and drive a DC brushless motor, so as to achieve the power-saving effect without the need of changing the existing pipeline wiring and control interface.

### BACKGROUND OF THE INVENTION

At present, energy has the issues of high price and severe environmental pollution, and thus power saving and alternative energy are promoted continuously. However, it is not easy to develop alternative energy, so that it is a top priority to save energy. For example, air-conditioning systems in a building generally consume a large amount of electricity and waste lots of energy, since the air-conditioning systems installed in spaces of different floors of the building include a plurality of ventilation ducts and plurality of air blowers to achieve the effects of adjusting room temperature and circulating air. The motors of these air blowers are AC single-phase three-speed motors which are low-efficiency and power-consuming motors, and their use wastes lots of energy. At present, a DC brushless motor with high efficiency and low power consumption is introduced into the market, so that if the air blower can be replaced by the DC brushless motor, then the high power consumption of the air-conditioning system can be improved to achieve the power saving and environmental protection effects.

The structure of a general air blower control circuit of the air-conditioning system is described below. In a conventional air-conditioning system, the motor of the air blower is AC single-phase three-speed motor that utilizes AC power, and an AC controller controls a speed (which is a high, mid or low speed), and a control interface such as a temperature sensor or a knob switch provides different rotational speed signals to the AC controller to control the rotational speed of the AC single-phase three-speed motor.

In the conventional air-conditioning system, the motor of the air blower motor is an AC single-phase three-speed motor that utilizes AC power, and the circuit structure includes a plurality of relay control circuits which may be turned on or off, and different relays are used for controlling the rotational speed of the AC single-phase three-speed motor, and the motor of the air blower of the air-conditioning system is an AC single-phase three-speed motor that utilizes AC power, and the circuit structure includes a plurality of relay-single pole double throw (Relay-SPDT) control circuits which may be turned on or off to switch the power, and the contact on a high-speed, mid-speed, or low-speed relay-single pole double throw (Relay-SPDT) control circuit is provided for controlling the AC single-phase three-speed motor.

Since most conventional air-conditioning systems use AC signals, or other electric appliances such as air filter systems or dehumidification systems also use AC signals, and the DC brushless motor cannot read the AC signals, therefore it is necessary to remove and replace all pipeline wiring for the use of the DC brushless motor, and such replacement not just incurs cost, but also wastes resources. In addition, the replacement of the whole pipeline wiring is a complicated task. If the whole system is replaced by a new one, there will be an additional cost for the control circuit and users cannot use the previously selected control interface anymore. Therefore, it is always an issue for related manufacturers to break through and switch to the use of a high-power and low-consumption DC brushless motor in the existing air-conditioning system with minimum cost and construction.

### SUMMARY OF THE INVENTION

In view of the aforementioned drawbacks of the prior art, it is a primary objective of the present invention to provide a control system that converts an AC signal into a DC signal, so as to control the operation of a DC brushless motor and achieve the power saving effect without the need of changing the existing pipeline wiring or control interface.

To achieve the aforementioned and other objectives, the present invention provides a control system electrically coupled between a main control module and a DC brushless motor, and the control system comprises a switching power conversion circuit, a voltage conversion circuit, a central processing circuit, a motor driving circuit and a switching circuit, wherein the switching power conversion circuit is coupled to the air-conditioning main control module for receiving an AC power, rectifying, bucking and filtering the AC power to form and supply a stable DC power for the operation of the DC brushless motor, so that a conventional air-conditioning system converts AC signals into DC signal to control and drive DC brushless motor, so as to achieve the power saving effect without the need of changing the existing pipeline wiring and control interface.

Specifically, the control system of the present invention has the following effects:

1. The control system is connected to the air-conditioning main control module for receiving an AC power, rectifying, bucking and filtering the AC power to form a stable DC power supplied for the operation of a DC brushless motor, so as to achieve the effects of improving efficiency and saving electric power.

2. The present invention allows the conventional air-conditioning system to change the sensing motor to the DC brushless motor without changing the existing pipeline wiring or control interface.

3. The rotational speed and the rotating position of a rotor in the DC brushless motor can be controlled during the operation of Hall components.

### BRIEF DESCRIPTION OF THE DRAWINGS

FIG. 1 is a schematic block diagram of a control system in accordance with a first preferred embodiment of the present invention;

FIG. 2 is a schematic circuit diagram of a control system in accordance with the first preferred embodiment of the present invention;

FIG. 3 is a schematic circuit diagram of a switching power conversion circuit in accordance with the first preferred embodiment of the present invention;

FIG. 4 is a schematic circuit diagram of a control system in accordance with a second preferred embodiment of the present invention; and

FIG. 5 is a schematic diagram showing a control system of the present invention applied in an air-conditioning system.

### DESCRIPTION OF THE PREFERRED EMBODIMENTS

The technical characteristics, contents, advantages and effects of the present invention will be apparent with the detailed description of a preferred embodiment accompanied with related drawings as follows.

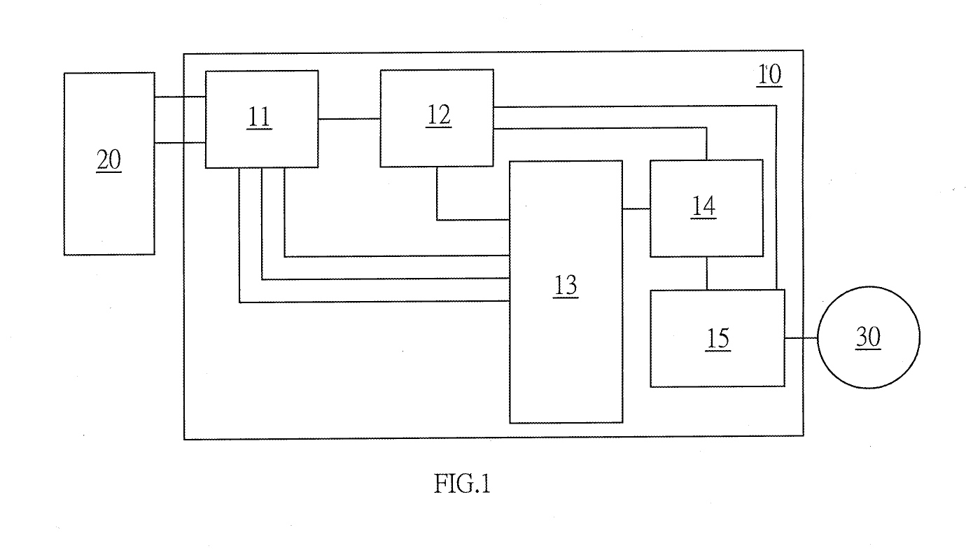

In FIG. 1, a control system 10 of the present invention is electrically coupled between a main control module 20 and a DC brushless motor 30, and the control system 10 comprises at least one switching power conversion circuit 11, a voltage conversion circuit 12, a central processing circuit 13, a motor driving circuit 14 and a switching circuit 15.

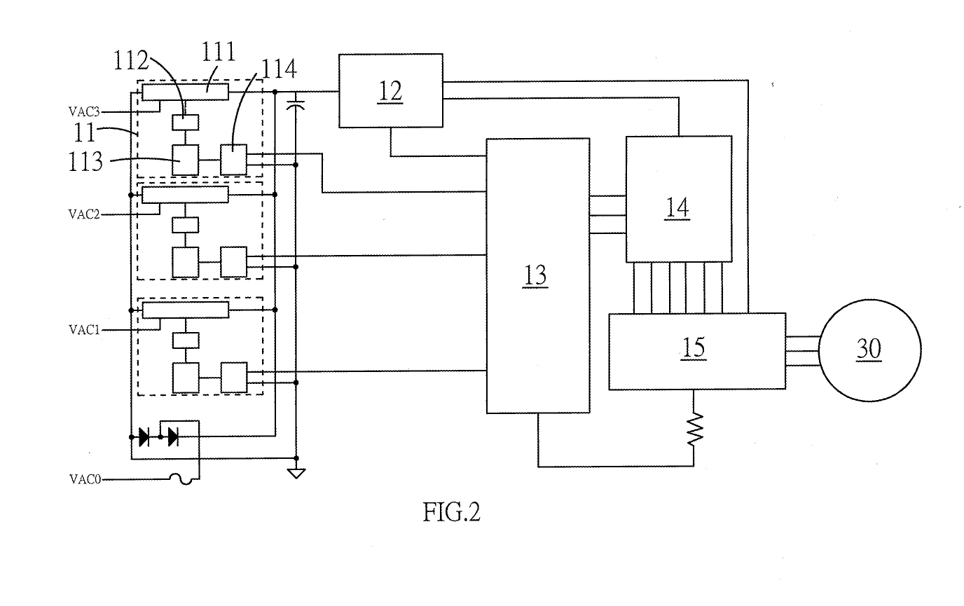

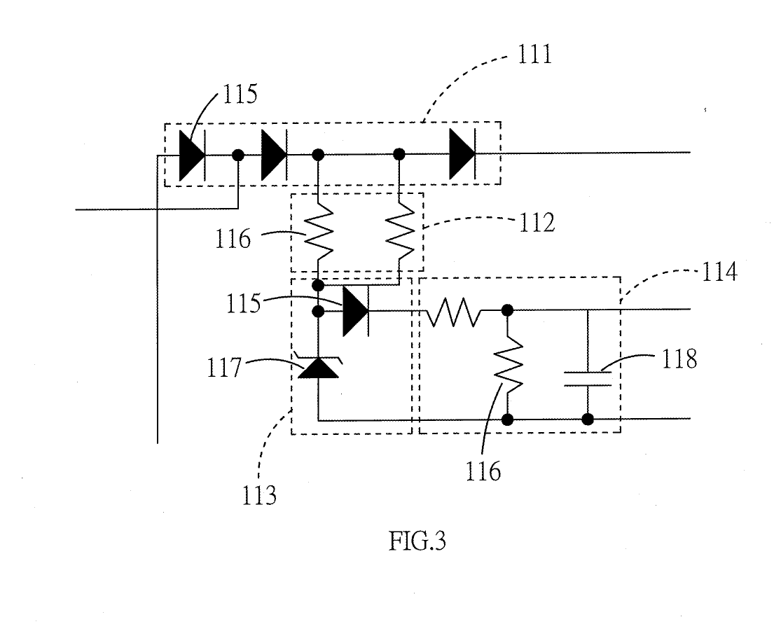

The switching power conversion circuit 11 is provided for connecting to the air-conditioning main control module 20, receiving an AC power, and converting the AC power into a DC power. In FIGS. 2 and 3, the switching power conversion circuit 11 includes a rectification element 111, a current limiting element 112, a voltage regulation element 113 and a filtering element 114 connected to one another.

Wherein, the rectification element 111 includes a plurality of diodes 115 serially connected in a forward direction, and the current limiting element 112 is coupled between the rectification element 111 and the voltage regulation element 113, and the current limiting element 112 includes at least one resistor 116, and the voltage regulation element 113 is coupled between the current limiting element 112 and the filtering element 114, and the voltage regulation element 113 includes serially connected diode 115 and Zener diode 117, and the filtering element 114 includes at least one resistor 116 and a capacitor 118 connected to each other.

The voltage conversion circuit 12 is connected to the switching power conversion circuit 11 for converting the DC power into at least one driving voltage.

The central processing circuit 13 is connected to the switching power conversion circuit 11 and the voltage conversion circuit 12 for receiving the driving voltage and a signal of the switching power conversion circuit 11. The motor driving circuit 14 is connected to the voltage conversion circuit 12 and the central processing circuit 13 for receiving the driving voltage and a signal of the central processing circuit 13, and converting the signal into a driving signal of a driving motor.

The switching circuit 15 is coupled to the motor driving circuit 14, the voltage conversion circuit 12 and the DC brushless motor 30 for receiving the driving voltage and the driving signal and driving the DC brushless motor 30 to operate. In a preferred embodiment of the present invention, the switching circuit 15 is a transistor.

When use, the air-conditioning main control module 20 supplies an AC power to the switching power conversion circuit 11, and rectification element 111 comprised of a plurality of serially connected diodes 115 rectifies the AC power, and the resistor 116 provides a current limiting effect, and the diode 115 and the Zener diode 117 regulate the voltage, and the resistor 116 and the capacitor 118 act as a filtering element to correct a voltage waveform and form a stable DC power, so as to complete the conversion of the AC power.

The voltage conversion circuit 12 receives the stable DC power and converts the DC power into at least one driving voltage, and the voltage conversion circuit 12 may be a buck converter for converting a DC power of a large voltage into a plurality of different driving voltages, such as a plurality of lower voltages to be supplied to the central processing circuit 13, the motor driving circuit 14 and the switching circuit 15 for their operation, and may be converted into a driving voltage for driving the DC brushless motor 30 to operate.

A signal of the switching power conversion circuit 11 is transmitted to the central processing circuit 13, and then processed by the central processing circuit 13 and converted by the motor driving circuit 14 into a driving signal for driving a motor. Finally the switching circuit 15 controls the operation of the DC brushless motor 30 according to the driving signal.

Wherein, the central processing circuit has the following control modes:

1. A sine wave driving mode or a square wave driving mode may be selected.

2. Different inputs of AC power at a front end may be detected as a basis for determining a rotational speed of the DC brushless motor. For example, the DC brushless motor is controlled according to different magnitudes of the inputted AC power to have different speeds such as 2, 3, and 4.

3. The voltage inputted to the motor may be modulated by a pulse width modulation (PWM) method.

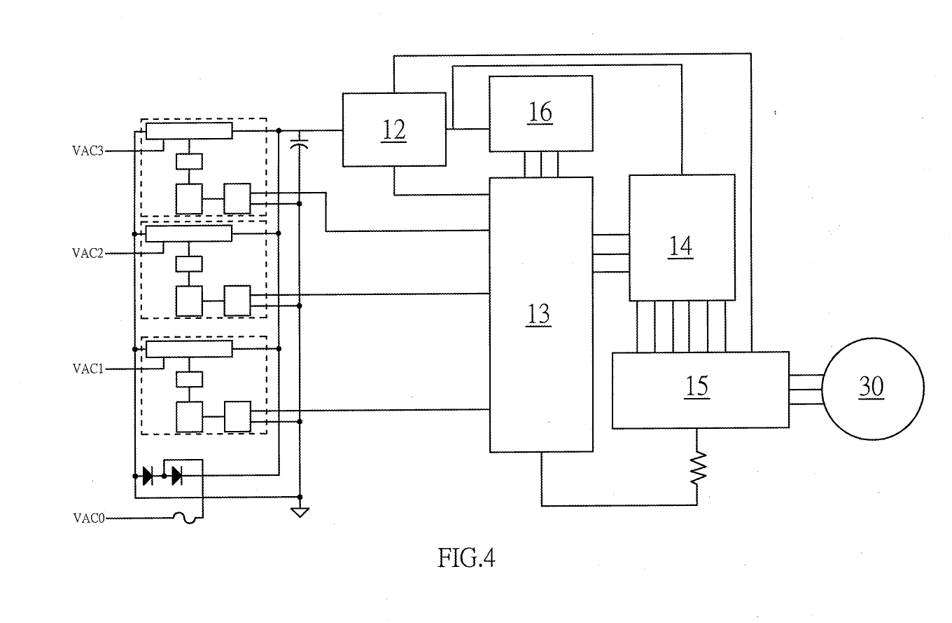

In addition, the control system further includes a Hall component 16 in the second preferred embodiment as shown in FIG. 4, the Hall component 16 is coupled to the voltage conversion circuit 12 and the central processing circuit 13 and provided for detecting a change of magnetic poles of a permanent magnet of a rotor installed in the DC brushless motor to form a weak Hall voltage and transmitting the voltage to the central processing circuit 13 to control the rotational speed and the rotating position of the rotor installed in the DC brushless motor.

It is noteworthy that the control system of the present invention may be integrated onto a printed circuit board, or installed between the air-conditioning main control module and the DC brushless motor, so that the conventional air-conditioning system can use the DC brushless motor instead of the sensing motor without the need of replacing the existing pipeline wiring or control interface, and also can use the operation of the DC brushless motor to achieve the effects of improving efficiency and saving power.

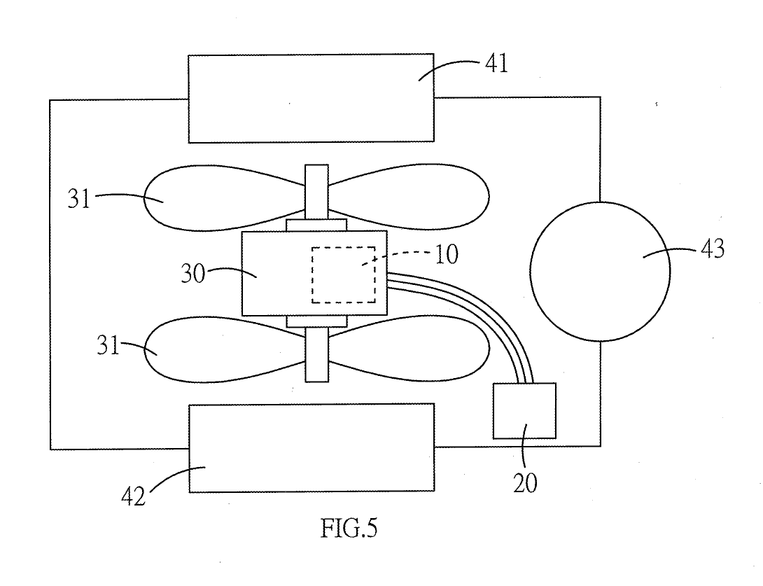

In a preferred embodiment of the present invention as shown in FIG. 5, the control system 10 is applied in an air-conditioning system 40, and the air-conditioning system 40 comprises a main control module 20 and a DC brushless motor 30, wherein the control system 10 is electrically coupled between the main control module 20 and the DC brushless motor 30, or built in the DC brushless motor 30 and then electrically coupled to the main control module 20 as shown in the figure. Wherein, the air-conditioning system 40 has an indoor end 41 and an outdoor end 42, and the DC brushless motor 30 is installed between the indoor end 41 and the outdoor end 42, and the DC brushless motor 30 includes a fan 31 configured to be responsive to the indoor end 41 and the outdoor end 42, and the control system 10 is coupled to the DC brushless motor 30 for driving the DC brushless motor 30 to operate, and the DC brushless motor 30 is provided for driving the fans 31 at both ends of the DC brushless motor 30. With the effect of a compressor 43, the fans 31 guide air to blow towards the indoor end 41 or the outdoor end 42 to achieve the expected effect of adjusting temperature.

Of course, the control system of the present invention may be applied to an air filter system or a dehumidification system, wherein the air filter system or the dehumidification system has a suction end and a discharge end, and the DC brushless motor is coupled to a fan, and the fan is installed between the suction end and the discharge end, so that air passing through the internal components can be purified or dehumidified.

While the invention has been described by means of specific embodiments, numerous modifications and variations could be made thereto by those skilled in the art without departing from the scope and spirit of the invention set forth in the claims.

What is claimed is:

1. A DC brushless motor control system applicable for AC power, comprising:
at least one switching power conversion circuit, for receiving an AC power, converting the AC power into a DC power;
a voltage conversion circuit, coupled to the switching power conversion circuit, for converting the DC power into at least one driving voltage;
a central processing circuit, coupled to the switching power conversion circuit and the voltage conversion circuit, for receiving the driving voltage;
a motor driving circuit, coupled to the voltage conversion circuit and the central processing circuit, for receiving the driving voltage and a signal of the central processing circuit, and converting the signal into a driving signal; and
a switching circuit, coupled to the motor driving circuit and the voltage conversion circuit, for receiving the driving signal.

2. The DC brushless motor control system applicable for AC power according to claim 1, wherein the switching power conversion circuit includes a rectification element, a current limiting element, a voltage regulation element and a filtering element coupled to one another.

3. The DC brushless motor control system applicable for AC power according to claim 2, wherein the rectification element includes a plurality of serially connected diodes.

4. The DC brushless motor control system applicable for AC power according to claim 2, wherein the current limiting element is coupled between the rectification element and the voltage regulation element, and the current limiting element includes at least one resistor.

5. The DC brushless motor control system applicable for AC power according to claim 2, wherein the voltage regulation element is coupled between the current limiting element and the filtering element, and the voltage regulation element includes a diode and a Zener diode connected in series with each other.

6. The DC brushless motor control system applicable for AC power according to claim 2, wherein the filtering element includes at least one resistor and a capacitor coupled to each other.

7. The DC brushless motor control system applicable for AC power according to claim 1, wherein the control system further includes a Hall component coupled to the voltage conversion circuit and the central processing circuit.

8. The DC brushless motor control system applicable for AC power according to claim 1, wherein the switching circuit is a transistor.

9. The DC brushless motor control system applicable for AC power according to claim 1, wherein the central processing circuit selects a sine wave driving mode or a square wave driving mode.

10. The DC brushless motor control system applicable for AC power according to claim 1, wherein the central processing circuit detects different inputs of AC power at a front end as a basis for determining a rotational speed of the DC brushless motor.

11. The DC brushless motor control system applicable for AC power according to claim 1, wherein the central processing circuit modulates a voltage inputted to the motor by a pulse width modulation method.

12. The DC brushless motor control system applicable for AC power according to claim 1, wherein the control system is applied in an air-conditioning system, and the air-conditioning system comprises a main control module and a DC brushless motor, and the control system is electrically coupled between the main control module and the DC brushless motor, and the switching circuit is coupled to the DC brushless motor for driving the DC brushless motor to operate.

13. The DC brushless motor control system applicable for AC power according to claim 12, wherein the air-conditioning system has an outdoor end and an indoor end, and both ends of the DC brushless motor are coupled to a fan separately, and the two fans are configured to be corresponsive to the outdoor end and the indoor end respectively.

14. The DC brushless motor control system applicable for AC power according to claim 1, wherein the control system is applied in an air filter system, and the air-conditioning system includes a main control module and a DC brushless motor, and the control system is electrically coupled between the main control module and the DC brushless motor, and the switching circuit is coupled to the DC brushless motor for driving the DC brushless motor to rotate.

15. The DC brushless motor control system applicable for AC power according to claim 14, wherein the air filter system has a suction end and a discharge end, and the DC brushless motor is coupled to a fan, and the fan is installed between the suction end and the discharge end.

16. The DC brushless motor control system applicable for AC power according to claim 1, wherein the control system is applied in a dehumidification system, and the air-conditioning system includes a main control module and a DC brushless motor, and the control system is electrically coupled between the main control module and the DC brushless motor, and the switching circuit is coupled to the DC brushless motor for driving the DC brushless motor to operate.

17. The DC brushless motor control system applicable for AC power according to claim 16, wherein the dehumidification system has a suction end and a discharge end, and the DC brushless motor is coupled to a fan, and the fan is installed between the suction end and the discharge end.
